(19) United States
(12) Patent Application Publication
(10) Pub. No.: US 2015/0302683 A1
(43) Pub. Date: Oct. 22, 2015

(54) GAMING MACHINE, GAMING SYSTEM, GAMING MACHINE INFORMATION DISPLAY METHOD, PROGRAM AND RECORDING MEDIUM

(71) Applicant: OMRON CORPORATION, Kyoto-shi, Kyoto (JP)

(72) Inventors: Katsumi MATSUSHITA, Kyoto (JP); Masataka KIMURA, Kyoto (JP)

(73) Assignee: OMRON CORPORATION, Kyoto-shi, Kyoto (JP)

(21) Appl. No.: 14/380,991

(22) PCT Filed: Dec. 7, 2012
(86) PCT No.: PCT/JP2012/081836

§ 371 Date: Aug. 26, 2014

(30) Foreign Application Priority Data
Mar. 13, 2012 (JP) 2012-056370

(51) Int. Cl. G07F 17/32; G06F 17/28

(52) U.S. Cl. CPC G07F 17/3211; G06F 17/289

(57) ABSTRACT

A gaming machine information display method includes a display control step of causing a display device to display a game content based on game content display information, an information acquisition step of acquiring nationality information on a customer who plays a game, and a display information producing step of producing the game content display information in a language corresponding to a customer's nationality indicated by the nationality information.

### BACKGROUND

1. Technical Field

The present invention relates to a gaming machine, a gaming system, a gaming machine information display method, a program, and a recording medium, which are used in amusement halls such as a casino and a pachinko parlor.

2. Related Art

For example, in amusement halls such as a pachinko parlor, gaming information is provided as service for a guest, namely, a player. As to the provision of the gaming information, for example, Patent Document 1 discloses an amusement hall system including a management device connected to each pachinko gaming machine and an information public terminal connected to the management device.

Specifically, the management device acquires an out signal indicating the number of out balls, a safe signal indicating the number of safe balls, a start signal, a big win signal, and a probability variation signal, which are output from each pachinko gaming machine, and the management device individually accumulates operation data of each pachinko gaming machine. Based on the data provided from the management device, the information public terminal displays a big win history data screen, a probability variation continuation start ranking screen, an under-probability-variation-continuation big win number ranking screen, an under-probability-variation start number ranking screen, and a model-by-model probability variation continuation start number ranking screen added with a model name and machine number of the pachinko gaming machine.

Accordingly, the player can recognize a recommended pachinko gaming machine from each screen displayed on the information public terminal, and select a desired pachinko gaming machine.

The provision of the gaming information is effectively used as one of measures to increase sales because the provision of the gaming information prompts a gambling spirit of the player to lead to improvement of a repeat rate.

### PRIOR ART DOCUMENT

### Patent Document

Patent Document 1: Japanese Unexamined Patent Publication No. 2006-158775

### SUMMARY

In the case that the player plays a game in a foreign amusement hall, usually the gaming information in the gaming machine of the amusement hall is displayed in a local language. The same holds true for the display of the game content for the player. In the case that the game content is displayed in the local language, it is not easy for a foreigner who is not familiar with the local language to enjoy the game in the amusement hall of a foreign country. Even if the display language of the game content can be selected from a plurality of languages, guidance to select the language is displayed in the local language. Therefore, it is considered that the foreigner does not easily perform a manipulation to select the display language. The display language in the gaming machine is particularly prominent in a casino in which peoples of various nationalities gather to play games.

One or more embodiments of the invention provides a gaming machine that can display a game content in a language being able to be understood by a customer (player) without forcing the customer to bear a burden, a gaming system, a gaming machine information display method, a program, and a recording medium.

A gaming machine according to one or more embodiments of the present invention includes: a display device; a display controller configured to cause the display device to display a game content based on game content display information; a first information acquisition unit configured to acquire nationality information on a customer who plays a game; and a display information producing unit configured to produce the game content display information in a language corresponding to a customer's nationality indicated by the nationality information and to provide the game content display information to the display controller.

According to one or more embodiments of the invention, in the case that the customer plays the game with the gaming machine, the game content is automatically displayed in a language corresponding to the customer's nationality on the display device of the gaming machine. That is, in the gaming machine, the game content can automatically be displayed in a language that can be understood by the customer without forcing the customer (player) to bear a burden.

### DETAILED DESCRIPTION

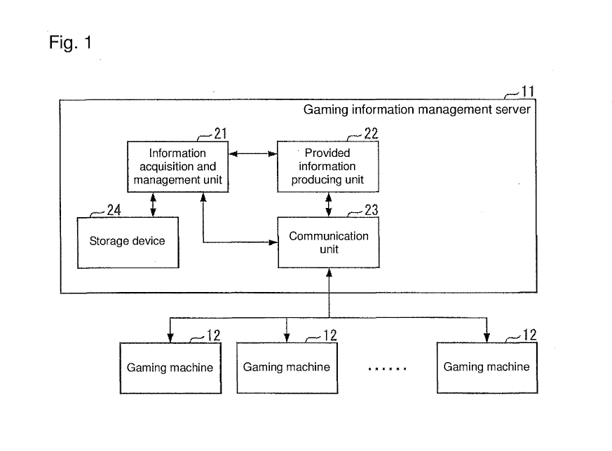

FIG. 1 is a block diagram illustrating a configuration of a gaming information providing system according to one or more embodiments of the present invention.

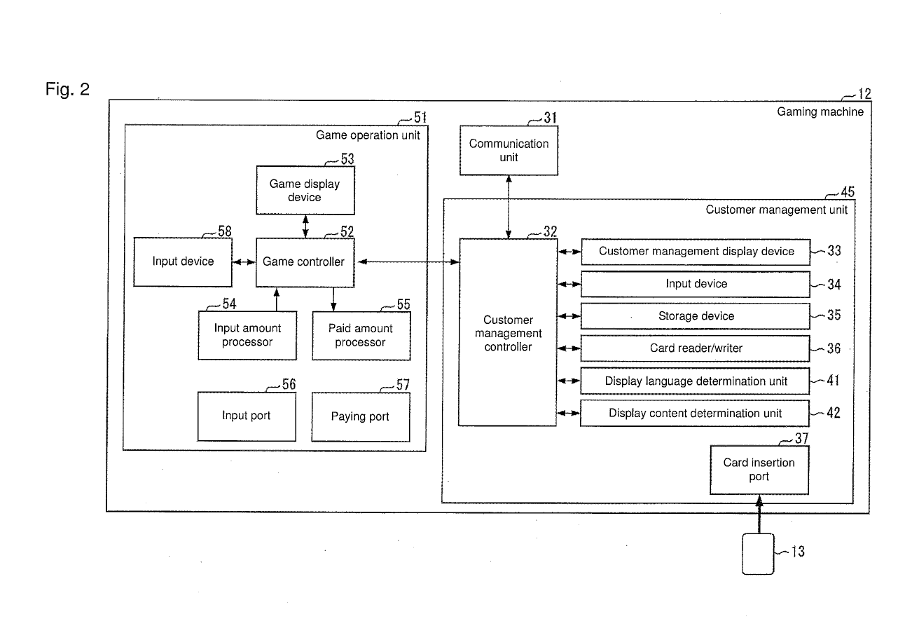

FIG. 2 is a block diagram illustrating an example of a configuration of a gaming machine in FIG. 1.

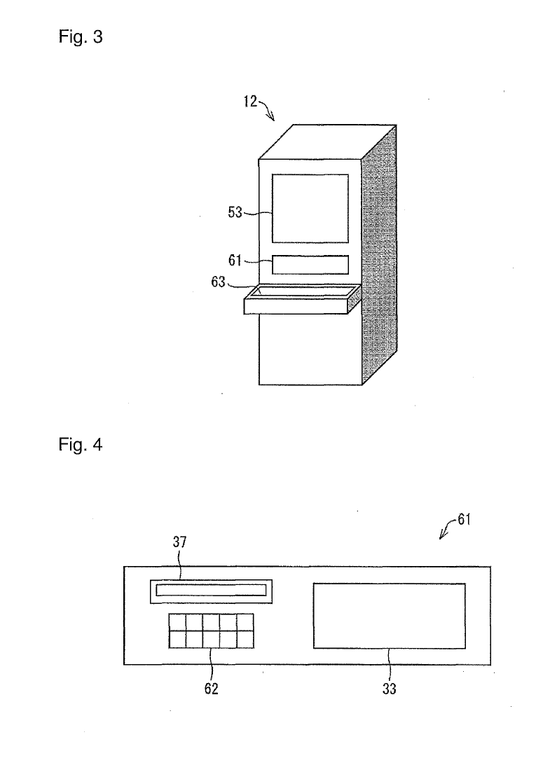

FIG. 3 is a perspective view illustrating an appearance of the gaming machine in FIG. 2.

FIG. 4 is a front view illustrating a customer management component in FIG. 3.

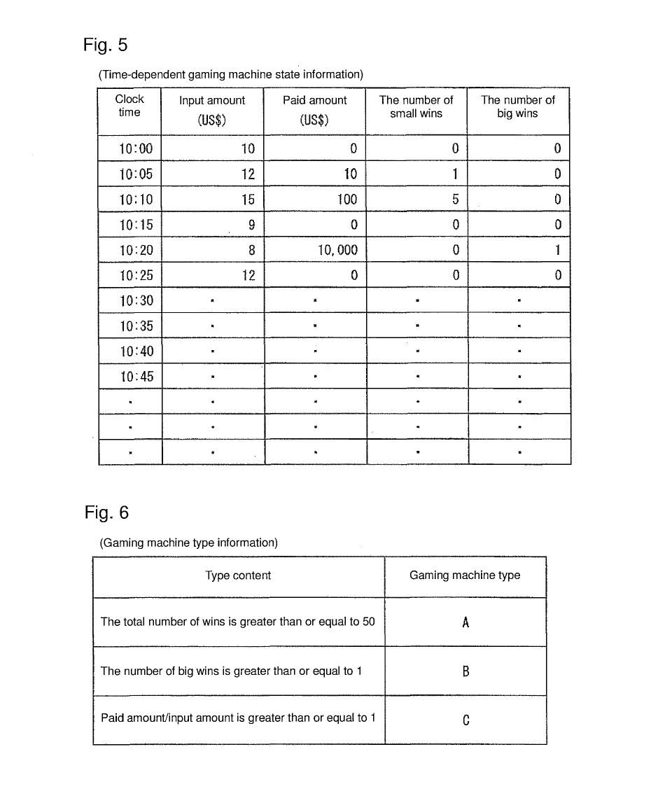

FIG. 5 is an explanatory diagram illustrating a time-dependent gaming machine state information management table for one gaming machine managed by an information acquisition and management unit in FIG. 1.

FIG. 6 is an explanatory diagram of a gaming machine type information management table illustrating a content of a gaming machine type managed by the information acquisition and management unit in FIG. 1.

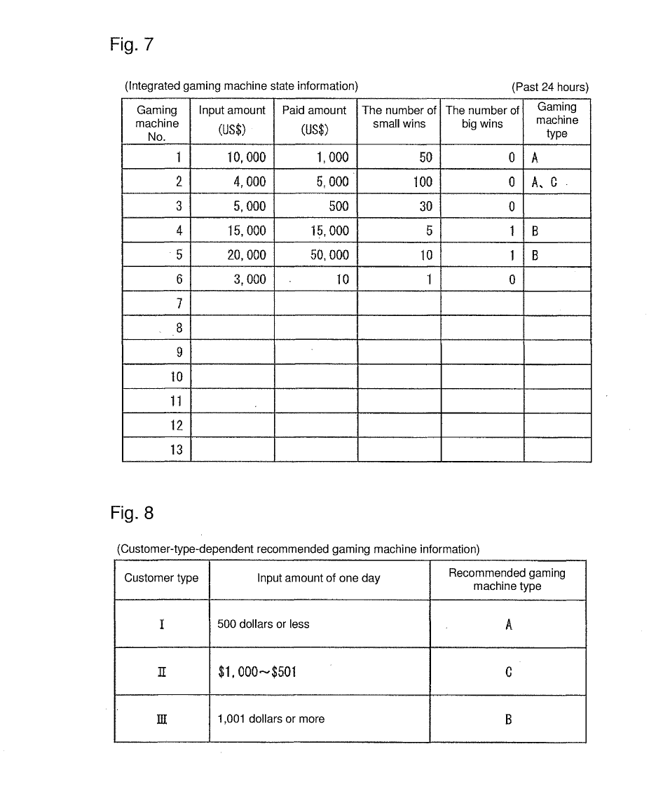

FIG. 7 is an explanatory diagram illustrating a time-dependent gaming machine state information management table managed by the information acquisition and management unit in FIG. 1.

FIG. 8 is an explanatory diagram illustrating a customer-type-dependent recommended gaming machine information management table managed by the information acquisition and management unit in FIG. 1.

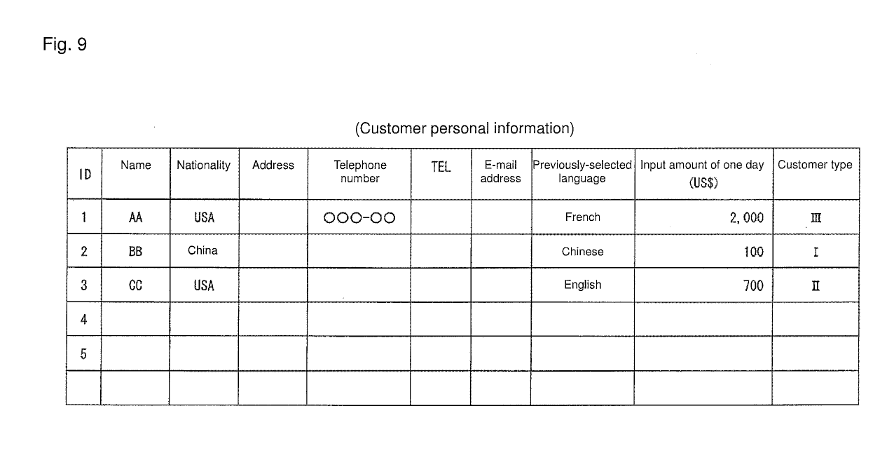

FIG. 9 is an explanatory diagram illustrating a customer personal information management table managed by the information acquisition and management unit in FIG. 1.

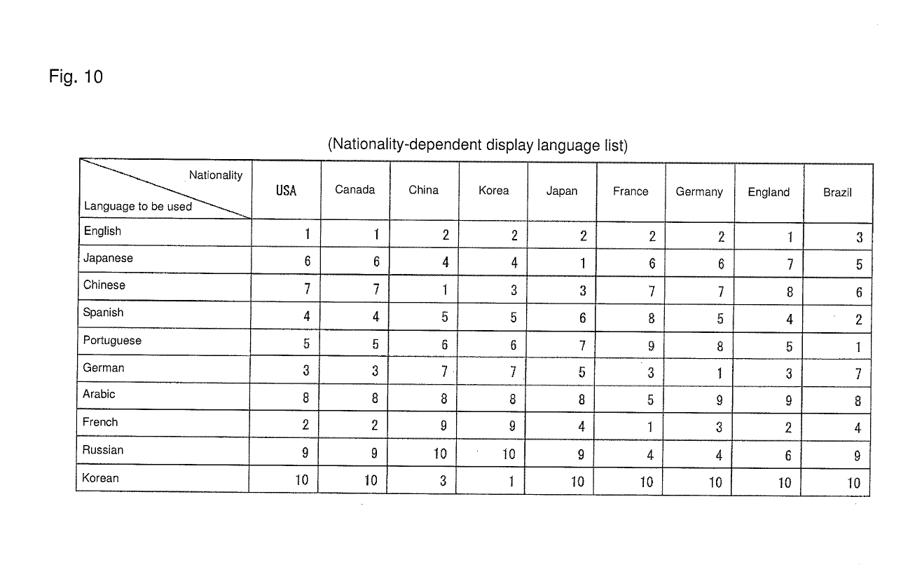

FIG. 10 is an explanatory diagram of a nationality-dependent priority display language list illustrating a priority order of a display language according to a customer's nationality in the gaming machine in FIG. 2.

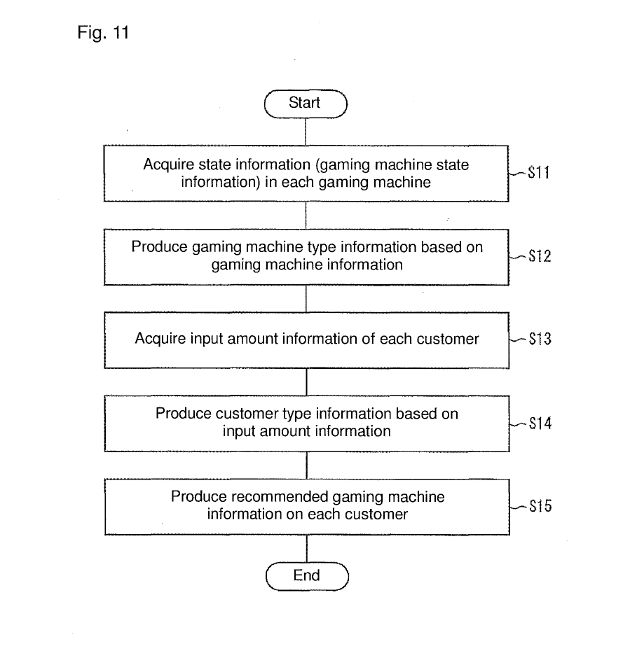

FIG. 11 is a flowchart illustrating recommended gaming machine information producing operation in a gaming information management server in FIG. 1.

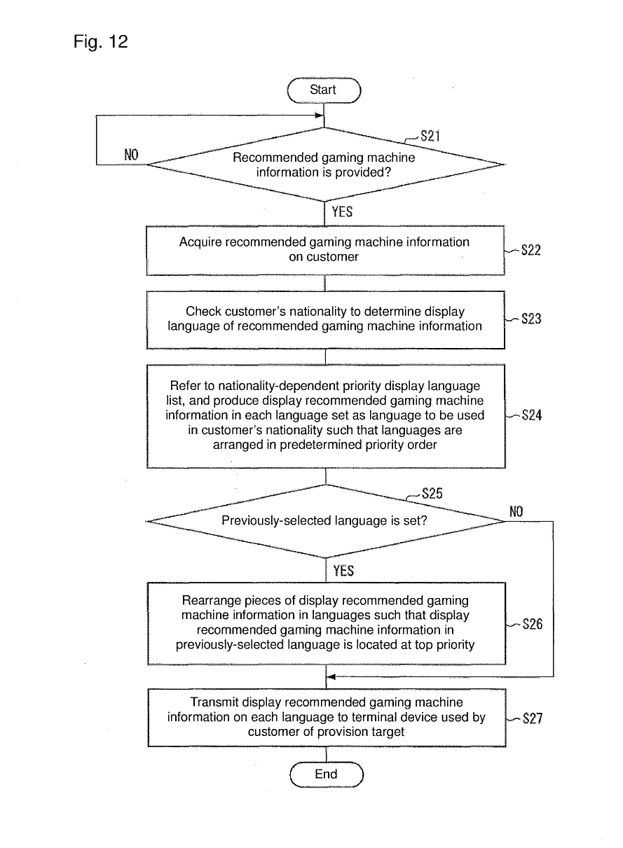

FIG. 12 is a flowchart illustrating recommended gaming machine information providing operation in the gaming machine in FIG. 1.

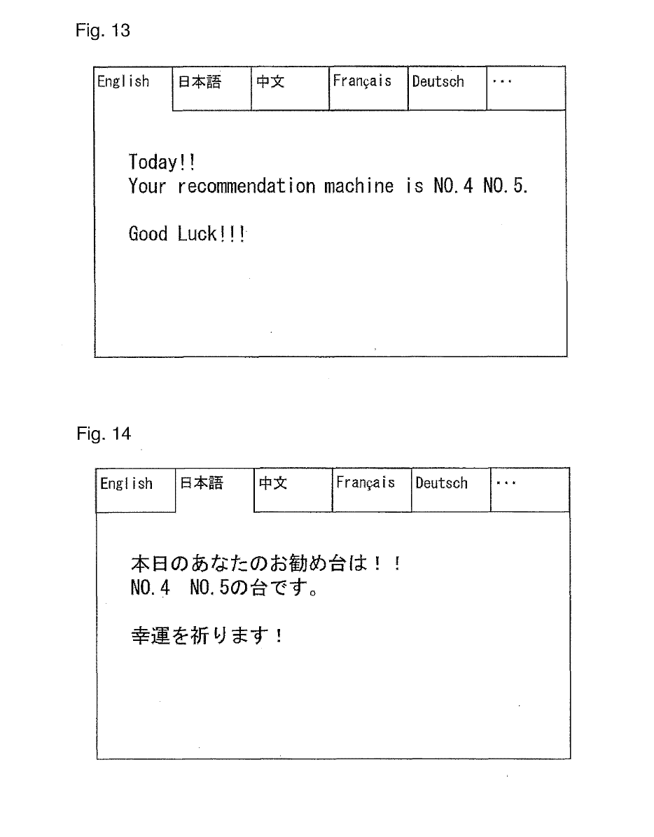

FIG. 13 is an explanatory view illustrating the recommended gaming machine information displayed on a display device of the gaming machine in FIG. 1.

FIG. 14 is an explanatory view illustrating a state in which the recommended gaming machine information in FIG. 13 is switched from English language display to Japanese language display.

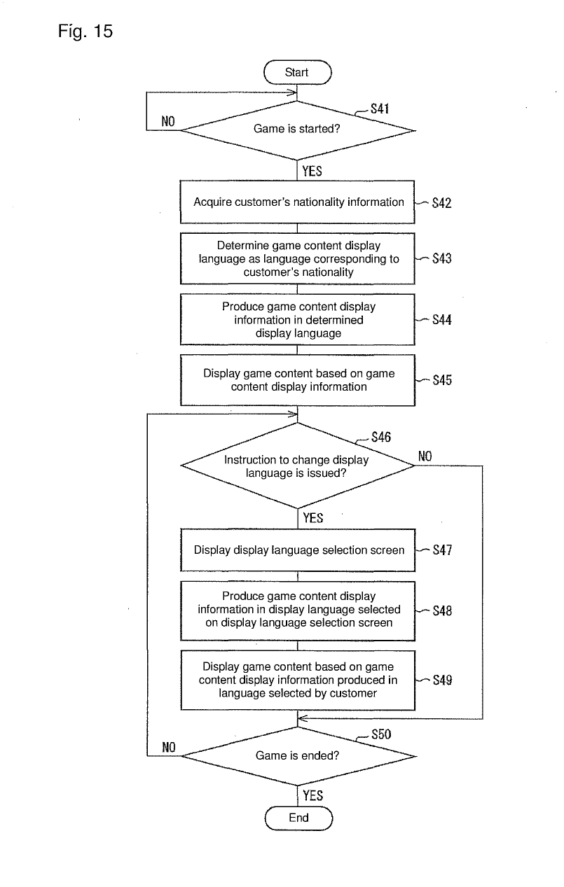

FIG. 15 is a flowchart illustrating game content display operation in the gaming machine in FIG. 2.

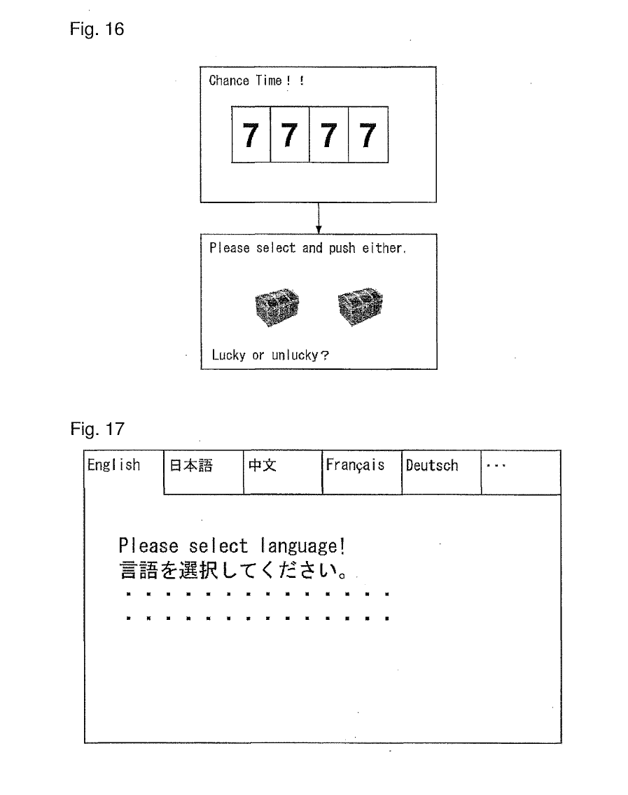

FIG. 16 is an explanatory view illustrating an example of a game content display screen displayed in a language according to the customer's nationality in operation of S45 in FIG. 15.

FIG. 17 is an explanatory view illustrating a language selection screen displayed on a game display device in operation of S47 in FIG. 15.

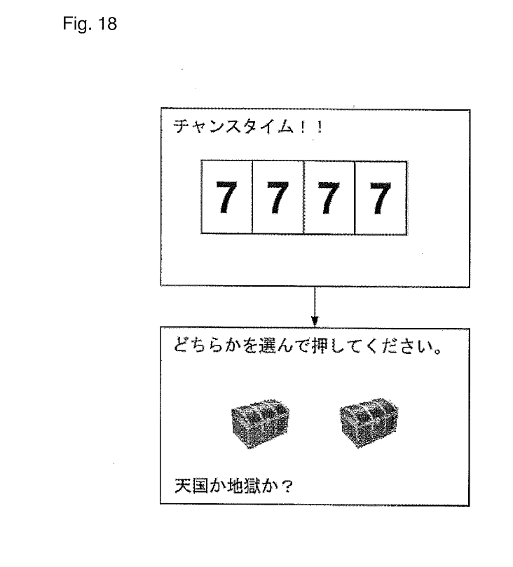

FIG. 18 is an explanatory view illustrating an example of the game content display screen displayed in a language selected on the language selection screen in operation of S49 in FIG. 15.

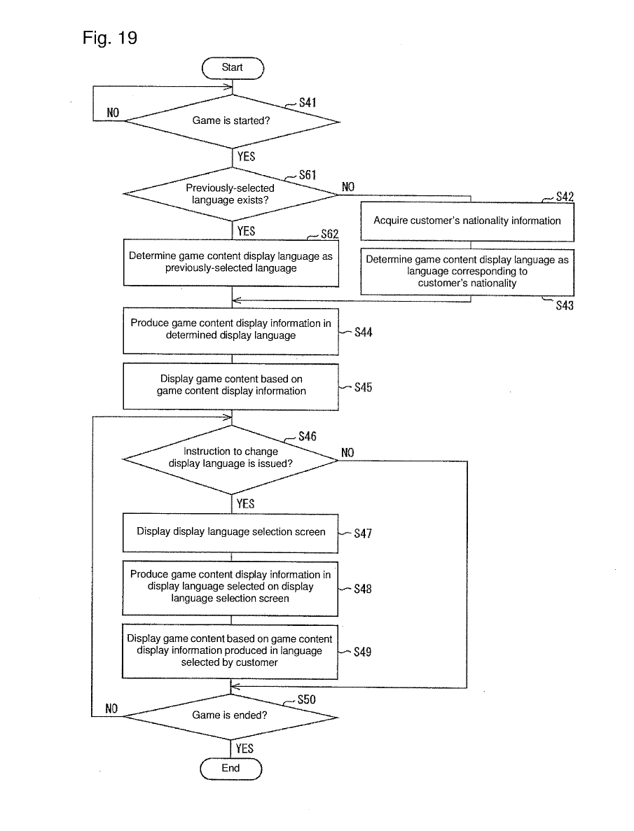

FIG. 19 is a flowchart illustrating another example of the operation to display the game content in the gaming machine in FIG. 15.

### DETAILED DESCRIPTION

Hereinafter, embodiments of the present invention will be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. An example in which one or more embodiments of the invention is applied to a gaming system included in a casino will be described below.

FIG. 1 is a block diagram illustrating a configuration of a gaming system according to one or more embodiments of the invention. As illustrated in FIG. 1, the gaming system includes gaming information management server (gaming information providing device) 11 and a plurality of gaming machines 12.

(Gaming Information Management Server)

Gaming information management server 11 is provided with a computer including a CPU, a RAM, and a ROM. Specifically, as illustrated in FIG. 1, gaming information management server 11 includes information acquisition and management unit (information management unit and second information acquisition unit) 21, provided information producing unit 22, communication unit 23, and storage device 24 as each functional unit.

Communication unit 23 conducts communication with gaming machine 12 connected to gaming information management server 11 in a wired or wireless manner, and transmits and receives information to and from gaming machine 12.

Information acquisition and management unit 21 manages gaming machine information on gaming machine 12 and customer information on a customer. These pieces of information are stored as a management table in storage device 24. The gaming machine information includes time-dependent gaming machine state information, integrated gaming machine state information, and gaming machine type information. The customer information includes customer personal information and customer-type-dependent recommended gaming machine information.

In the gaming machine information, the time-dependent gaming machine state information indicates a state at predetermined time intervals with respect to each gaming machine 12. For example, the time-dependent gaming machine state information is managed using a time-dependent gaming machine state information management table in FIG. 5. FIG. 5 is an explanatory diagram illustrating a time-dependent gaming machine state information management table for one gaming machine 12 managed by information acquisition and management unit 21.

In the time-dependent gaming machine state information management table, the amount of money input to gaming machine 12, the amount of money paid from gaming machine 12, the number of small wins in gaming machine 12, and the number of big wins in gaming machine 12 are managed in each gaming machine 12. Pieces of original information on these management items are provided from each gaming machine 12 to gaming information management server 11. In the example in FIG. 5, each item is updated every 5 minutes.

The gaming machine type information indicates speculation of each gaming machine 12 as a gaming machine type. For example, the gaming machine type information is managed using a gaming machine type information management table in FIG. 6. FIG. 6 is an explanatory diagram of the gaming machine type information management table illustrating a content of the gaming machine type managed by information acquisition and management unit 21. In the example in FIG. 6, gaming machine 12 in which the total number of wins including the number of small wins and the number of big wins is larger than or equal to 50 in the past 24 hours is set to gaming machine type A, gaming machine 12 in which the number of big wins is larger than or equal to 1 in the past 24 hours is set to gaming machine type B, and gaming machine 12 in which a ratio of the paid amount to the input amount is larger than or equal to 1 in the past 24 hours is set to gaming machine type C.

The integrated gaming machine state information indicates state information on gaming machine 12 obtained from the time-dependent gaming machine state information in the past 24 hours and a type (gaming machine type) of each gaming machine 12 that is set by referring to the gaming machine type information in FIG. 6 based on the state information. For example, the integrated gaming machine state information is managed using an integrated gaming machine state information management table in FIG. 7. FIG. 7 is an explanatory diagram illustrating a time-dependent gaming machine state information management table managed by information acquisition and management unit 21. In the example in FIG. 7, the input amount, the paid amount, the number of small wins, the number of big wins, and the gaming machine type of each gaming machine 12 in the past 24 hours are indicated as the integrated gaming machine state information.

In the customer information, the customer-type-dependent recommended gaming machine information indicates gaming machine 12 (recommended gaming machine) to be recommended to the customer based on the amount input to gaming machine 12 by the customer in one day. For example, the customer-type-dependent recommended gaming machine information is managed using a customer-type-dependent recommended gaming machine information management table in FIG. 8. FIG. 8 is an explanatory diagram illustrating the customer-type-dependent recommended gaming machine information management table managed by information acquisition and management unit 21.

In the example in FIG. 8, a recommended gaming machine type is set to gaming machine type A for the customer (customer type I) who inputs the amount of 500 dollars or less to gaming machine 12 in one day, the recommended gaming machine type is set to gaming machine type B for the customer (customer type II) who inputs the amount of 501 to 1,000 dollars to gaming machine 12 in one day, and the recommended gaming machine type is set to gaming machine type C for the customer (customer type III) who inputs the amount of 1,001 dollars or more to gaming machine 12 in one day.

The information indicating the input amount of the customer in one day is provided from each gaming machine 12 used by the customer to gaming information management server 11. That is, in the case that the customer uses gaming machine 12, customer card (customer storage device) 13 is inserted in card insertion port 37 of gaming machine 12. In gaming machine 12, customer card 13 is read, and customer personal information (including customer identification information) recorded in customer card 13 is transmitted to gaming information management server 11. While customer card 13 is inserted in card insertion port 37, gaming machine 12 transmits the information on the amount input to gaming machine 12 by the customer and the information on the amount paid from gaming machine 12 to gaming information management server 11 at predetermined time intervals. Information acquisition and management unit 21 of gaming information management server 11 can produce the information indicating the input amount of the customer in one day based on the information provided from gaming machine 12.

As illustrated in FIG. 9, the customer personal information indicates personal information on each customer. FIG. 9 is an explanatory diagram illustrating a customer personal information management table managed by information acquisition and management unit 21. In the example in FIG. 9, the customer personal information includes pieces of basic information such as a name, an address, a telephone number (and an e-mail address), and a nationality of the customer. The customer personal information also includes information on the language (previously-selected language) previously selected as display language information by the customer. Additionally, the customer personal information includes information indicating the amount input to gaming machine 12 by the customer in one day and, based on the information, information indicating a customer type that is set to the customer by referring to the customer-type-dependent recommended gaming machine information in FIG. 8.

Provided information producing unit 22 acquires the recommended gaming machine information on the customer indicated by the customer identification information from information acquisition and management unit 21 in the case that the recommended gaming machine information is provided as the gaming information to terminal device 12. The recommended gaming machine information indicates gaming machine 12 to be recommended to the customer. Provided information producing unit 22 causes communication unit 23 to transmit the recommended gaming machine information acquired from information acquisition and management unit 21 to gaming machine 12 which is used by the customer and is indicated by the customer identification information.

(Gaming Machine)

Gaming machine 12 is provided with a computer including a CPU, a RAM, and a ROM. For example, gaming machine 12 is a slot machine, and many slot machines are installed in a casino. FIG. 2 is a block diagram illustrating an example of a configuration of gaming machine 12.

As illustrated in FIG. 2, gaming machine 12 includes customer management unit 45, game operation unit 51, and communication unit 31. Customer management unit 45 includes customer management controller (first information acquisition unit, display controller) 32, display language determination unit (display information producing unit) 41, display content determination unit (display information producing unit) 42, customer management display device 33, input device 34, storage device 35, and card reader/writer (customer information reader, information reader/writer, and first information acquisition unit) 36. Customer management unit 45 includes card insertion port 37 in which customer card 13 is inserted.

Game operation unit 51 is a functional unit having an original gaming function of gaming machine 12. Game operation unit 51 includes game controller (display controller) 52, game display device 53, input amount processor 54, paid amount processor 55, input port 56, paying port 57, and input device 58.

Communication unit 31 is used when gaming machine 12 transmits and receives data to and from gaming information management server 11 in the wired or wireless manner. For example, customer management display device 33 is constructed with a liquid crystal display device, and displays various pieces of information under the control of customer management controller 32. Input device 34 is used when the customer performs an input manipulation to gaming machine 12 (customer management unit 45). The various pieces of information are stored in storage device 35. Card reader/writer 36 reads and writes information from and in customer card 13 inserted in card insertion port 37.

Customer management controller 32 of customer management unit 45 controls write and read operations that are performed to customer card 13 by card reader/writer 36. Therefore, customer management controller 32 acquires the information that is recorded in customer card 13 with card reader/writer 36. The information includes information on the customer's nationality. The information also includes the information on the previously-selected language when there is the information on the previously-selected language. Customer management controller 32 controls the display operation of customer management display device 33.

Display language determination unit 41 checks the customer's nationality indicated by the customer's nationality information acquired by customer management controller 32, and determines the language corresponding to the customer's nationality with respect to the recommended gaming machine information received from gaming information management server 11 by communication unit 31.

Display content determination unit 42 refers to a nationality-dependent priority display language list in FIG. 10 to put the recommended gaming machine information provided from gaming information management server 11 into the state in which the recommended gaming machine information is translated into each language indicated in the list as the language to be used according to the nationality. In this case, display content determination unit 42 arranges the displayed languages in a priority order set in the list. In the case that the previously-selected language exists, display content determination unit 42 rearranges the displayed languages such that the display of the previously-selected language is located at the top priority (located in a front row).

As illustrated in FIG. 10, nationality-dependent priority display language list indicates the priority order of the language to be used according to the customer's nationality. The priority order is indicated by a numerical number. The nationality-dependent priority display language list is stored in storage device 35.

FIG. 10 is an explanatory diagram of the nationality-dependent priority display language list illustrating the priority order of the display language according to the customer's nationality in gaming machine 12. In the example of the nationality-dependent priority display language list in FIG. 10, in the case that the customer's nationality is USA, the priority order of the language to be used is English, French, German, Spanish, Portuguese, Japanese, Chinese, Arabic, Russian, and Korean.

Display content determination unit 42 produces the game content display information displayed on game display device 53 in the language (the language corresponding to the customer's nationality) determined by display language determination unit 41. In the case that the previously-selected language exists, display content determination unit 42 produces the game content display information in the previously-selected language. Display content determination unit 42 also produces display information for a language selection screen.

The pieces of information produced by display content determination unit 42 are supplied from customer management controller 32 to game controller 52, and displayed on game display device 53 under the control of game controller 52. The recommended gaming machine information and the display information for the language selection screen may be displayed on customer management display device 33 under the control of customer management controller 32.

In game operation unit 51, game display device 53 includes a touch panel on a liquid crystal display device, and displays the game content under the control of game controller 52. Game display device 53 may display the recommended gaming machine information and the language selection screen in addition to the game content.

Input amount processor 54 calculates the amount of money (game medium) input through input port 56 by the customer (player), and notifies game controller 52 of the amount of money. In the case that the customer becomes a winner in the game, paid amount processor 55 processes the amount (game medium) paid from paying port 57 under the control of game controller 52.

Input device 58 includes the touch panel of game display device 53, and is manipulated by the customer in the game of gaming machine 12.

FIG. 3 is a perspective view illustrating an appearance of gaming machine 12. FIG. 4 is a front view illustrating customer management component 61 in FIG. 3. As illustrated in FIG. 3, gaming machine 12 includes game display device 53 in an upper portion of a front surface thereof and customer management component 61 below game display device 53. As illustrated in FIG. 4, customer management component 61 includes keyboard 62 in addition to customer management display device 33 and card insertion port 37. Manipulation display device 63 is provided below customer management component 61 while projected forward from the front surface of gaming machine 12. For example, manipulation display device 63 includes the touch panel on the liquid crystal display device. Keyboard 62 constitutes input device 34 of customer management unit 45 in FIG. 2, and manipulation display device 63 constitutes input device 58 of game operation unit 51.

For example, customer card 13 inserted in card insertion port 37 of gaming machine 12 is constructed with an IC card, and provided to a customer who comes to the casino. The customer carries customer card 13 in the casino.

Operations of the gaming information providing system according to one or more embodiments of the present invention will be described below.

(Registration of Basic Information in Customer Personal Information)

Operation to register the customer personal information will be described. The customer carries customer card 13 in the casino. Customer card 13 is issued at a manned reception counter. In this case, at the reception counter, the customer personal information is registered in customer card 13 by inputting the customer personal information to a terminal device based on a passport, a driver's license or the like that identifies the person. In this case, the basic information in the customer personal information, namely, name, nationality, address, telephone number and the like are registered.

The basic information input from the terminal device at the reception counter is transmitted from the terminal device to gaming information management server 11. In gaming information management server 11, communication unit 23 receives the basic information and transmits the basic information to information acquisition and management unit 21. When acquiring the customer basic information, information acquisition and management unit 21 registers the customer basic information in the customer personal information management table.

The basic information in the customer personal information registered in the customer personal information management table of gaming information management server 11 is not limited to the above items, but any item may be used as the basic information as long as the item can identify the customer and recognize the customer's nationality. The basic information recorded in customer card 13 may be the information indicating the customer's nationality and the information (customer identification information) that can identify the customer.

In the case that only the game content is displayed in gaming machine 12, the information (basic information) recorded in customer card 13 may be the information indicating the customer's nationality.

(Production of Recommended Gaming Machine Information)

The recommended gaming machine information producing operation as the gaming information will be described below. In the operation, the recommended gaming machine information reflecting a customer's preference is produced in each customer. FIG. 11 is a flowchart illustrating the recommended gaming machine information producing operation in gaming information management server 11.

In producing the recommended gaming machine information, information acquisition and management unit 21 of gaming information management server 11 acquires the gaming machine state information (gaming machine information) on each gaming machine 12 (S11). The gaming machine state information indicates a gaming machine state such as the input amount, the paid amount, the number of small wins, and the number of big wins in a predetermined time period (for example, past 24 hours) of each gaming machine 1.

Then information acquisition and management unit 21 produces the gaming machine type information based on the acquired gaming machine state information (S12). The gaming machine type information indicates the type of each gaming machine 1 classified by gambling such as the total number of wins including the small win and the big win, the existence or non-existence of the big win, and the rate of the paid amount to the input amount of gaming machine 1.

Information acquisition and management unit 21 acquire the input amount information in each customer (S13). The input amount information indicates the amount input to gaming machine 1 by each customer in a predetermined time period (for example, one day). The input amount information is preference information indicating the preference of each customer for the game of gaming machine 1.

Then information acquisition and management unit 21 produces the customer type information based on the input amount information on each customer (S14). The customer type information indicates the type of each customer classified by a degree of preference of the customer for the gamble.

Information acquisition and management unit 21 produces the recommended gaming machine information on each customer from the gaming machine type information and the customer type information (S15). The recommended gaming machine information on each customer indicates recommended gaming machine 1 to the customer according to the customer's preference.

The recommended gaming machine information producing operation performed by information acquisition and management unit 21 will be described in detail below.

When the customer plays the game with one of gaming machines 12, the customer starts the game after inserting customer card 13 in card insertion port 37 of gaming machine 12. When the customer ends the game, the customer pulls customer card 13 out of card insertion port 37.

When customer card 13 is inserted in card insertion port 37, the customer identification information recorded in customer card 13 is read by card reader/writer 36 and transmitted to gaming information management server 11. Therefore, gaming information management server 11 can identify the customer who plays the game with gaming machine 12.

There is no limitation to the configuration identifying the customer who plays the game with gaming machine 12. For example, the customer may manually input the identification information (for example, a customer ID number) from input device 34 of gaming machine 12 with no use of customer card 13, and the identification information may be transmitted to gaming information management server 11.

When the customer plays the game while customer card 13 is inserted in card insertion port 37 of gaming machine 12, the amount input to input port 56 in the game is checked by input amount processor 54, and output to game controller 52 as information on the amount input by the customer indicated by the customer identification information. At predetermined time intervals or in each game, game controller 52 notifies customer management controller 32 of the input amount information on each customer, and communication unit 31 transmits the input amount information on each customer to gaming information management server 11.

When the customer plays the game while customer card 13 is inserted in card insertion port 37 of gaming machine 12, the amount paid from paying port 57 in the game is processed by paid amount processor 55 under the control of game controller 52. In this case, game controller 52 notifies customer management controller 32 of the paid amount information on each customer indicated by the customer identification information at predetermined time intervals or in each game, and communication unit 31 transmits the paid amount information on each customer to gaming information management server 11.

In each gaming machine 12, irrespective of the existence or non-existence of the customer identification information (irrespective of the existence or non-existence of customer card 13), the information (input amount information on each gaming machine 12) on the amount input to input port 56, the information (paid amount information on each gaming machine 12) on the amount paid through paying port 57, the information on the number of small wins, and the information on the number of big wins are output from communication unit 31 to gaming information management server 11 at predetermined time intervals or in each game.

In gaming information management server 11, when communication unit 23 receives the input amount information on each customer, the paid amount information on each customer, the input amount information on each gaming machine 12, the paid amount information on each gaming machine 12, the information on the number of small wins, and the information on the number of big wins, these pieces of information are transmitted to information acquisition and management unit 21. When receiving the pieces of information, information acquisition and management unit 21 stores the pieces of information in storage device 24.

Then information acquisition and management unit 21 reads the pieces of information from storage device 24 to produce the management tables.

With respect to the time-dependent gaming machine state information management table in FIG. 5, information acquisition and management unit 21 produces the pieces of information on the input amount, the paid amount, the number of small wins, and the number of big wins from the input amount information, the paid amount information, the information on the number of small wins, and the information on the number of big wins of each gaming machine 12.

With respect to the integrated gaming machine state information management table in FIG. 7, information acquisition and management unit 21 produces the pieces of information on the input amount, the paid amount, the number of small wins, and the number of big wins of each gaming machine 12 from the input amount information, the paid amount information, the information on the number of small wins, and the information on the number of big wins of each gaming machine 12 in the past 24 hours.

With respect to the integrated gaming machine state information management table in FIG. 7, Information acquisition and management unit 21 produces the item of the gaming machine type by referring to the gaming machine type information management table in FIG. 6. Specifically, gaming machine 1 in which the total number of wins is greater than or equal to 50 is extracted from the information on the number of small wins and the information on the number of big wins of each gaming machine 12 in one day (past 24 hours), and set to gaming machine type A. Gaming machine 1 in which the number of big wins is greater than or equal to 1 is extracted from the information on the number of big wins of each gaming machine 12 in one day, and set to gaming machine type B. (Paid amount/input amount) is calculated from the input amount information and the paid amount information of each gaming machine 12 in one day, and gaming machine 1 in which (paid amount/input amount) is greater than or equal to 1 is extracted, and set to gaming machine type C.

As described earlier, based on the personal information input in gaming machine 12, information acquisition and management unit 21 produces the basic information (name, nationality, address, and telephone number) in the customer personal information with respect to the customer personal information management table in FIG. 9. The input amount in one day is produced by obtaining the input amount in one day from the input amount information on each customer.

The customer type is obtained from the input amount in one day by referring to the customer-type-dependent recommended gaming machine information management table in FIG. 8. Specifically, the customer whose amount input to gaming machine 12 is less than or equal to 500 dollars in one day is set to customer type I (recommended gaming machine type A), the customer whose amount input to gaming machine 12 ranges from 501 to 1,000 dollars in one day is set to customer type II (recommended gaming machine type B), the customer whose amount input to gaming machine 12 is greater than or equal to 1,001 dollars in one day is set to customer type III (recommended gaming machine type C).

(Provision of Display Recommended Gaming Machine Information)

The recommended gaming machine information providing operation in gaming machine 12 will be described below.

Gaming machine 12 provides the customer who plays the game with the recommended gaming machine information indicating gaming machine 12 to be recommended to the customer by the display on customer management display device 33 or game display device 53. Hereinafter, it is assumed that the recommended gaming machine information is displayed on customer management display device 33.

As a first case, the recommended gaming machine information providing operation is performed when the customer makes a request to display the recommended gaming machine information by manipulating gaming machine 12, for example, by manipulating input device 34. As a second case, the recommended gaming machine information providing operation is performed when customer card 13 is inserted in card insertion port 37 of gaming machine 12.

In the second case, customer management controller 32 performs the recommended gaming machine information providing operation, when customer card 13 is inserted in card insertion port 37 and read by card reader/writer 36.

FIG. 12 is a flowchart illustrating the recommended gaming machine information providing operation in gaming machine 12.

In the case that the recommended gaming machine information is provided to the customer in gaming machine 12, customer card 13 in which the customer identification information is recorded is in the state inserted in card insertion port 37 of gaming machine 12. The customer identification information is read by card reader/writer 36 and transmitted to gaming information management server 11. Accordingly, gaming information management server 11 can specify the customer, namely, gaming machine 12 to which the recommended gaming machine information should be provided.

When the recommended gaming machine information is provided in gaming machine 12 (S21), customer management controller 32 acquires the recommended gaming machine information on the customer corresponding to the customer identification information of customer card 13 from gaming information management server 11 (S22). In the case that the previously-selected language is registered in customer personal information in FIG. 9, customer management controller 32 also acquires the information indicating the previously-selected language.

Then, display language determination unit 41 checks the customer's nationality indicated by the customer identification information of customer card 13, determines the display language of the recommended gaming machine information, and notifies display content determination unit 42 of the determined display language (S23). In the case that the information indicating the previously-selected language exists, display language determination unit 41 also notifies display content determination unit 42 of the information indicating the previously-selected language.

Display content determination unit 42 refers to the nationality-dependent priority display language list in FIG. 10 to produce display recommended gaming machine information in each language indicated in the list as the language to be used according to the nationality. In this case, display content determination unit 42 arranges the pieces of recommended gaming machine information in the languages in the priority order set in the list (S24).

When the previously-selected language is set (S25), display content determination unit 42 rearranges the pieces of display recommended gaming machine information in the languages such that the previously-selected language is located at the top priority (located in the front row) (S26).

Then customer management controller 32 causes customer management display device 33 to display the display recommended gaming machine information in each language produced by display content determination unit 42 (S27).

FIG. 13 is an explanatory view illustrating the recommended gaming machine information displayed on customer management display device 33 of gaming machine 12. In the example in FIG. 13, the recommended gaming machine information shows that the gaming machines having the numbers 4 and 5 are recommended to the customer. In the recommended gaming machine information in FIG. 13, the customer's nationality is Japan, and the previously-selected language is English. Accordingly, in FIG. 13, English is displayed as the first priority although Japanese has the first priority in the priority order of the language to be used in the case that the nationality is Japan in the nationality-dependent priority display language list in FIG. 10.

In gaming machine 12, the display language of the recommended gaming machine information can be switched while the recommended gaming machine information is displayed on the display device. In this case, the customer manipulates input device 34 to select the language to be used (display language), thereby switching the display language. For touch panel-type customer management display device 33 of gaming machine 12, the customer touches a tab of the language to be used (display language) in the displayed recommended gaming machine information, thereby switching the display language.

FIG. 14 is an explanatory view illustrating a state in which the recommended gaming machine information in FIG. 13 is switched from English language display to Japanese language display.

In gaming machine 12, in addition to the first and second cases, the recommended gaming machine information may be provided at predetermined time intervals or at timing the recommended gaming machine information on each customer changes.

In the case that the recommended gaming machine information is provided at predetermined time intervals, after first provision of a day of the recommended gaming machine information from gaming machine 12 to the customer, the recommended gaming machine information may be provided to gaming machine 12 that is used by the same customer at predetermined time intervals, for example, every one hour.

The recommended gaming machine information on each customer changes in the case that at least one of the gaming machine type and the customer type changes. In the case that at least one of the gaming machine type and the customer type changes, the operation to produce the recommended gaming machine information on each customer and the operation to provide the recommended gaming machine information to terminal device 12 are similar to those described above.

(Display of Game Content)

The game content display operation in gaming machine 12 will be described below. The display of the game content relates to the game that is performed in game display device 53 when the customer plays the game with gaming machine 12.

In gaming machine 12, the game content is displayed in the language corresponding to the nationality of the customer who plays the game with gaming machine 12. The information indicating the nationality is acquired from customer card 13 by card reader/writer 36. Accordingly, for displaying the game content, it is only necessary for customer card 13 to record at least the information indicating the customer's nationality as the customer personal information.

FIG. 15 is a flowchart illustrating operation to display the game content in gaming machine 12.

When the customer starts the game with gaming machine 12 (S41), customer management controller 32 acquires from customer card 13 the information (customer's nationality information) indicating the nationality of the customer who plays the game (S42). The information recorded in customer card 13 is read by card reader/writer 36.

Then, display language determination unit 41 checks the customer's nationality from the customer's nationality information, determines the language corresponding to the nationality to be the display language of the game content, and notifies display content determination unit 42 of the determined display language (S43).

Display content determination unit 42 produces the game content display information that is used to display the game content in the display language determined by display language determination unit 41, and display content determination unit 42 transmits the game content display information to game controller 52 (S44).

Based on the game content display information produced by display content determination unit 42, game controller 52 causes game display device 53 to display the game content as illustrated in FIG. 16 (S45). Accordingly, game display device 53 displays the game content in the language corresponding to the customer's nationality.

When the customer wants to change the display language in which the game content is displayed, the customer manipulates input device 34 to issue an instruction to change the display language (S46).

For example, input device 34 to be manipulated is a display language change button provided as input device 34 or a display language change button displayed on game display device 53 including a touch panel. In this case, the explanations of the display language change button in major languages may be added to the display language change button.

When the instruction to change the display language is issued, display content determination unit 42 produces the display information for the language selection screen. The display information for the language selection screen is transmitted to game controller 52 through customer management controller 32. Based on the display information for the language selection screen, game controller 52 causes game display device 53 to display the language selection screen in FIG. 17 (S47).

When the customer touches a language selection tab in the language selection screen to select the display language for the game content, game display device 53 notifies customer management controller 32 of the selected display language. Customer management controller 32 notifies display content determination unit 42 of the selected display language. Therefore, display content determination unit 42 produces the game content display information in the language selected in the language selection screen (S48). The produced game content display information is transmitted to game controller 52 through customer management controller 32.

Based on the game content display information reproduced by display content determination unit 42, game controller 52 causes game display device 53 to display the game content as illustrated in FIG. 18 (S49). Accordingly, game display device 53 displays the game content in the display language selected by the customer. The operations in S46 to S49 are repeated until the game is ended (S50).

FIG. 16 is an explanatory view illustrating an example of the game content display screen displayed in the language according to the customer's nationality in the operation of S45.

FIG. 17 is an explanatory view illustrating the language selection screen displayed on game display device 53 in the operation of S47. In the language selection screen, a message “please select language” is displayed in a plurality of languages, and the selection tab is displayed in the plurality of languages in, for example, the upper post portion of the screen. The plurality of languages are the languages indicated in the nationality-dependent priority display language list in FIG. 10 and correspond to the customer's nationalities, and the selection tabs are displayed in the plurality of languages in the priority order of the languages to be used according to the nationalities indicated in the nationality-dependent priority display language list.

FIG. 18 is an explanatory view illustrating an example of the game content display screen displayed in the language selected on the language selection screen in the operation of S49. The game content display screen in FIG. 18 is switched from the display in English of FIG. 16 to the display in Japanese selected in the language selection screen.

The game content display operation in gaming machine 12 in the case that the language (previously-selected language) selected by the customer is recorded as the previous game content display language in customer card 13 will be described below. It is assumed that, in the case that the customer selects a language other than the language corresponding to the customer's nationality as the game content display language in the language selection screen, card reader/writer 36 records the selected language as the previously-selected language in customer card 13.

FIG. 19 is a flowchart illustrating the game content display operation based on the previously-selected language in gaming machine 12. In the operations in FIG. 19, the operations in S61 and S62 are added to the operations in FIG. 15.

As illustrated in FIG. 19, when the customer starts the game with gaming machine 12 (S41), customer management controller 32 determines whether the information on the previously-selected language is recorded in customer card 13 (S61).

As a result of the determination in S61, when the information on the previously-selected language is recorded in customer card 13, display language determination unit 41 determines the previously-selected language to be the game content display language, and notifies display content determination unit 42 of the determined game content display language (S62).

On the other hand, when the information on the previously-selected language is not recorded in customer card 13 in S61, the information (customer's nationality information) indicating the nationality of the customer who plays the game is acquired from customer card 13 (S42).

Then, display language determination unit 41 checks the customer's nationality from the customer's nationality information, determines the language corresponding to the nationality to be the display language of the game content, and notifies display content determination unit 42 of the determined display language (S43).

Display content determination unit 42 produces the game content display information that is used to display the game content in the display language determined by display language determination unit 41, and display content determination unit 42 transmits the game content display information to game controller 52 (S44).

Because the operations in S45 to S50 are similar to those in FIG. 15, the description is neglected. In the case that a new language is selected as the game content display language by the operation in S48, card reader/writer 36 records the selected language as the previously-selected language in customer card 13.

As described above, in the case that the customer plays the game, the game content is automatically displayed in the language corresponding to the customer's nationality on game display device 53 of gaming machine 12. Accordingly, the game content can automatically be displayed in the language that can be understood by the customer without forcing the customer to bear a burden, and gaming machine 12 can have high user-friendliness.

The game content display language can be selected by the customer in the language selection screen, gaming machine 12 can properly meet the case that the customer is better at the language different from the language corresponding to the customer's nationality.

For example, gaming information management server 11 classifies gaming machines 12 into a plurality of gaming machine types by the total number of wins including the small win and the big win, the number of big wins, the rate of the paid amount to the input amount of gaming machine 12 in the past 24 hours. For example, gaming information management server 11 classifies the customers into a plurality of customer types by the amount input to gaming machine 12 by the customer in one day (or past 24 hours). The recommended gaming machine information indicating gaming machine 12 of a type corresponding to the customer type is produced by a combination of each customer type and each gaming machine type, and provided to the customer (terminal device 12 used by the customer). Accordingly, the gaming information reflecting the customer's preference can be provided.

The recommended gaming machine information provided from gaming information management server 11 to terminal device 12 used by the customer is translated into the language corresponding to the customer's nationality, and translated into the plurality of languages corresponding to the nationalities indicated in the nationality-dependent priority display language list. Accordingly, even if the casino provided with the gaming information providing system including gaming information management server 11 is a foreign casino, the customer (player) does not bear the burden of language understanding in the casino, but the customer can easily use the recommended gaming machine information to enjoy the game. A utilization ratio of gaming machine 12 can be improved in the casino.

(Program and Recording Medium for Gaming Information Management Server)

Each block of the gaming system including gaming information management server 11 and gaming machine 12, particularly each block of gaming machine 12 may be constructed with hardware logic or software using a CPU (Central Processing Unit).

That is, the gaming system includes the CPU that executes a command of a control program implementing each function, a ROM (Read Only Memory) in which the program is stored, a RAM (Random Access Memory) on which the program is expanded, and a storage device (recording medium), such as a memory, in which the program and various pieces of data are stored. The recording medium in which a program code (executable format program, intermediate code program, and source program) of the gaming system control program that is of the software implementing each function is recorded in a computer-readable manner is supplied to the gaming system, and a computer (or CPU or MPU) reads and executes the program code recorded in the recording medium.

Examples of the recording medium include tape systems such as a magnetic tape and a cassette tape, disk systems including magnetic disks such as a floppy (registered trademark) disk and a hard disk and optical disks such as a CD-ROM, an MO, an MD, a DVD, and a CD-R, card systems such as an IC card (including a memory card) and an optical card, and semiconductor memory systems such as a mask ROM, an EPROM, an EEPROM (registered trademark), and a flash ROM.

The gaming system may be connectable to a communication network, and the program code may be supplied through the communication network. There is no particular limitation to the communication network. For example, the Internet, an intra-net, an extra-net, a LAN, an ISDN, a VAN, a CATV communication network, a virtual private network, a telephone line network, a mobile communication network, and a satellite communication network can be used as the communication network. There is no particular limitation to a transmission medium constituting the communication network. For example, both a wired transmission medium such as IEEE1394, a USB, a power-line carrier, a cable TV line, a telephone line, and an ADSL line and a wireless transmission medium such as an infrared ray including IrDA and a remote controller, Bluetooth (registered trademark), 802.11 wireless, HDR, a mobile phone network, a satellite line, and a digital terrestrial broadcasting network can be used as the transmission medium. Additionally, one or more embodiments of the invention can be implemented in the form of a carrier-embedded computer data signal in which the program code is embodied by electronic transmission.

As described above, the gaming machine according to one or more embodiments of the invention includes: a display device; a display controller that causes the display device to display a game content based on game content display information; a first information acquisition unit that acquires nationality information on a customer who plays a game; and a display information producing unit that produces the game content display information in a language corresponding to a customer's nationality indicated by the nationality information and provides the game content display information to the display controller.

The gaming machine information display method according to one or more embodiments of the invention includes: a display control step of causing a display device to display a game content based on game content display information; an information acquisition step of acquiring nationality information on a customer who plays a game; and a display information producing step of producing the game content display information in a language corresponding to a customer's nationality indicated by the nationality information.

According to the above configuration, the display controller (in the display control step) causes the display device to display the game content based on the game content display information. The first information acquisition unit (in the information acquisition step) acquires the nationality information on the customer who plays the game. The display information producing unit (in the display information producing step) produces the game content display information in the language corresponding to the customer's nationality indicated by the nationality information and provides the game content display information to the display controller.

Therefore, in the case that the customer plays the game with the gaming machine, the game content is automatically displayed in the language corresponding to the customer's nationality on the display device of the gaming machine. That is, in the gaming machine, the game content can automatically be displayed in the language that can be understood by the customer (player) without forcing the customer to bear a burden.

In the gaming machine, the first information acquisition unit may include a customer information reader configured to read the nationality information recorded in a customer storage device, the customer storage device being carried with the customer who plays the game with the gaming machine.

According to the above configuration, the nationality information on the customer who plays the game with the gaming machine is read from the customer storage device, such as an IC card, which is carried with the customer, by the customer information reader of the first information acquisition unit included in the gaming machine. Therefore, the nationality information on the customer can easily be acquired when the nationality information on the customer is recorded in the customer storage device.

In the gaming machine, the display information producing unit may produce display information for a language selection screen in which one of a plurality of languages can be selected based on an input issuing an instruction to change a display language of the game content, provide the display information for the language selection screen to the display controller, produce the game content display information in the language selected in the language selection screen, and provide the game content display information to the display controller, and the display controller may cause the display device to display the language selection screen based on the display information for the language selection screen, and when the display information producing unit provides second game content display information to the display controller after providing first game content display information to the display controller, cause the display device to display the game content based on the second game content display information instead of the first game content display information.

According to the above configuration, when the instruction to change the display language of the game content is input, the display information producing unit produces the display information for the language selection screen in which one of the plurality of languages can be selected, and provides the display information for the language selection screen to the display controller. The display controller causes the display device to display the language selection screen based on the display information for the language selection screen provided from the display information producing unit. When the customer selects one of the languages in the language selection screen, the display information producing unit produces the game content display information in the language selected in the language selection screen, and provides the game content display information to the display controller. When the display information producing unit provides the second game content display information (for example, the game content display information produced in the language selected in the language selection screen) to the display controller after providing the first game content display information (for example, the game content display information produced in the language corresponding to the customer's nationality) to the display controller, the display controller causes the display device to display the game content based on the second game content display information instead of the first game content display information.

Accordingly, a customer who is better at the language different from the language corresponding to the customer's nationality can play the game having the game content displayed in the desired language, and the user-friendliness of the gaming machine can be improved.

In the gaming machine, the display information producing unit may include a nationality-dependent display language list indicating a plurality of display languages set based on the customer's nationality, and set the plurality of display languages set based on the customer's nationality indicated in the nationality-dependent display language list as the plurality of display languages that can be selected in the language selection screen.

According to the above configuration, the display information producing unit sets the plurality of display languages indicated in the nationality-dependent display language list as the plurality of languages that can be selected in the language selection screen. In this case, the plurality of languages in the nationality-dependent display language list, namely, the plurality of languages set to be selectable in the language selection screen are set based on the customer's nationality, so that the suitable language can be selected as the display language of the game content.

In the gaming machine, the customer information reader may be an information reader/writer configured to read and write information from and in the customer storage device, and the customer information reader may record in the customer storage device, when a language other than the language corresponding to the customer's nationality is selected as a display language of the game content in a language selection screen, information on the selected language as information on a previously-selected language, the first information acquisition unit may acquire the information on the previously-selected language from the customer storage device, and the display information producing unit may produce display information for the language selection screen in which one of a plurality of languages can be selected based on an input issuing an instruction to change the display language of the game content, provide the display information for the language selection screen to the display controller, produce the game content display information in the language selected in the language selection screen, provide the game content display information to the display controller, and when the first information acquisition unit acquires the information on the previously-selected language, produce the game content display information in the previously-selected language indicated by the information on the previously-selected language instead of the language corresponding to the customer's nationality.

According to the above configuration, when the instruction to change the display language of the game content is input, the display information producing unit produces the display information for the language selection screen in which one of the plurality of languages can be selected, and provides the display information for the language selection screen to the display controller. The display controller causes the display device to display the language selection screen based on the display information for the language selection screen provided from the display information producing unit. The customer information reader is the information reader/writer configured to read and write information from and in the customer storage device, and the customer information reader records, when the language other than the language corresponding to the customer's nationality is selected as the display language of the game content in the language selection screen, the information on the selected language as the information on the previously-selected language in the customer storage device. The display information producing unit produces the game content display information in the previously-selected language instead of the language corresponding to the customer's nationality, when the first information acquisition unit acquires the information on the previously-selected language.

Therefore, the game content is displayed in not the language corresponding to the customer's nationality, but the previously-selected language, when the previously-selected language selected as the display language of the game content by the customer in the past is recorded in the customer storage device. Accordingly, the user-friendliness at the time the customer plays the game can further be enhanced.

The gaming system according to one or more embodiments of the invention includes: a gaming information providing device; and the above-mentioned gaming machine in plural, a game medium being paid in or paid out to the gaming machine in a game, the gaming machine being configured to transmit and receive information to and from the gaming information providing device in a wired or wireless manner. In the gaming system, the gaming information providing device includes: a second information acquisition unit configured to acquire, from the plurality of gaming machines, gaming machine information including paying-out information indicating a paying-out status of the game medium in each gaming machine, customer identification information identifying a plurality of customers who play the games with the gaming machines, and preference information indicating a preference of each customer for the game of the gaming machine; a storage device in which each piece of information acquired by the second information acquisition unit is stored; an information management unit configured to classify the plurality of customers into a plurality of customer types based on the preference information while classifying the plurality of gaming machines into a plurality of gaming machine types based on the gaming machine information; and a provided information producing unit configured to produce recommended gaming machine information indicating a recommended gaming machine for each customer from the gaming machine type and the customer type and to provide the recommended gaming machine information to the gaming machine. In the gaming system, the display information producing unit of the gaming machine is configured to produce display recommended gaming machine information in a language corresponding to a customer's nationality indicated by the nationality information from the recommended gaming machine information provided from the gaming information providing device, and provide the display recommended gaming machine information to the display controller, and the display controller of the gaming machine is configured to cause the display device to display the recommended gaming machine information based on the display recommended gaming machine information.

According to the above configuration, the second information acquisition unit of the gaming information providing device acquires, from the plurality of gaming machines, the gaming machine information including the paying-out information indicating the paying-out status of the game medium in each gaming machine, the customer identification information identifying the plurality of customers who play the games with the gaming machines, and the preference information indicating the preference of each customer for the game of the gaming machine. Each piece of information acquired by the second information acquisition unit is stored in the storage device.

The information management unit classifies the plurality of gaming machines into the plurality of gaming machine types based on the gaming machine information. The information management unit also classifies the plurality of customers into a plurality of customer types based on the preference information. The provided information producing unit produces the recommended gaming machine information indicating the recommended gaming machine for each customer from the gaming machine type and the customer type, and provides the recommended gaming machine information to the gaming machine.

The display information producing unit of the gaming machine produces the display recommended gaming machine information in the language corresponding to the customer's nationality indicated by the nationality information from the recommended gaming machine information provided from the gaming information providing device, and provides the display recommended gaming machine information to the display controller. The display controller of the gaming machine causes the display device to display the recommended gaming machine information based on the display recommended gaming machine information.

Therefore, in the case that the customer plays the game with the gaming machine, the game content is automatically displayed in the language corresponding to the customer's nationality on the display device of the gaming machine. In the gaming machine, the game content can automatically be displayed in the language that can be understood by the customer (player) without forcing the customer to bear the burden.

In the gaming machine, the recommended gaming machine information effective for the customer, namely, the player can be provided in the language corresponding to the customer's nationality while reflecting not only the state of the gaming machine but also the customer's preference.

In the gaming system, the preference information may be paying-in information indicating a paying-in status of the game medium for the gaming machine in each customer.

According to the above configuration, because the preference information on the customer is the paying-in information indicating the paying-in status of the game medium for the gaming machine in each customer, the recommended gaming machine information produced with the paying-in information as the preference information on the customer can properly reflect the present preference of the customer.

The invention is not limited to the above embodiments, but various changes can be made without departing from the scope of the claims. It is noted that an embodiment obtained by properly combining technical means disclosed in the above embodiments is also included in the technical scope of the invention.

One or more embodiments of the present invention can be used in gaming machines such as a slot machine and a pachinko machine and a gaming system that is installed in a casino or pachinko parlor including the gaming machines.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF SYMBOLS

11 gaming information management server (gaming information providing device)
12 gaming machine
13 customer card (customer storage device)
21 information acquisition and management unit (information management unit, second information acquisition unit)
22 provided information producing unit
23 communication unit
24 storage device
31 communication unit
32 customer management controller (first information acquisition unit, display controller)
33 customer management display device
34 input device
35 storage device
36 card reader/writer (customer information reader, information reader/writer, first information acquisition unit)
37 card insertion port
41 display language determination unit (display information producing unit)
42 display content determination unit (display information producing unit)
45 customer management unit
51 game operation unit
52 game controller (display controller)
53 game display device
54 input amount processor
55 paid amount processor
56 input port
57 paying port
58 input device
61 customer management component
63 manipulation display device

1. A gaming machine comprising:
a display device;
a display controller that causes the display device to display a game content based on game content display information;
a first information acquisition unit that acquires nationality information on a customer who plays a game; and
a display information producing unit that produces the game content display information in a language corresponding to a customer's nationality indicated by the nationality information and provides the game content display information to the display controller.

2. The gaming machine according to claim 1,
wherein the first information acquisition unit comprises a customer information reader that reads the nationality information recorded in a customer storage device, and
wherein the customer storage device is carried with the customer who plays the game with the gaming machine.

3. The gaming machine according to claim 1,
wherein the display information producing unit produces display information for a language selection screen in which one of a plurality of languages can be selected based on an input issuing an instruction to change a display language of the game content,
wherein the display information producing unit provides the display information for the language selection screen to the display controller,
wherein the display information producing unit produces the game content display information in the language selected in the language selection screen,
wherein the display information producing unit provides the game content display information to the display controller,
wherein the display controller causes the display device to display the language selection screen based on the display information for the language selection screen, and
wherein, when the display information producing unit provides second game content display information to the display controller after providing first game content display information to the display controller, the display controller causes the display device to display the game content based on the second game content display information instead of the first game content display information.

4. The gaming machine according to claim 3,
wherein the display information producing unit comprises a nationality-dependent display language list indicating a plurality of display languages set based on the customer's nationality, and
wherein the display information producing unit sets the plurality of display languages set based on the customer's nationality indicated in the nationality-dependent display language list as the plurality of display languages that can be selected in the language selection screen.

5. The gaming machine according to claim 2,
wherein the customer information reader is an information reader/writer that reads and writes information from and in the customer storage device,
wherein the customer information reader records in the customer storage device, when a language other than the language corresponding to the customer's nationality is selected as a display language of the game content in a language selection screen, information on the selected language as information on a previously-selected language,
wherein the first information acquisition unit acquires the information on the previously-selected language from the customer storage device,
wherein the display information producing unit produces display information for the language selection screen in which one of a plurality of languages can be selected based on an input issuing an instruction to change the display language of the game content,
wherein the display information producing unit provides the display information for the language selection screen to the display controller,
wherein the display information producing unit produces the game content display information in the language selected in the language selection screen,
wherein the display information producing unit provides the game content display information to the display controller, and
wherein, when the first information acquisition unit acquires the information on the previously-selected language, the display information producing unit produces the game content display information in the previously-selected language indicated by the information on the previously-selected language instead of the language corresponding to the customer's nationality.

6. A gaming system comprising:
a gaming information providing device; and
a plurality of the gaming machine according to claim 1,
wherein a game medium is paid in or paid out to the gaming machine in a game,
wherein the gaming machine transmits and receives information to and from the gaming information providing device in a wired or wireless manner,
wherein the gaming information providing device comprises:
a second information acquisition unit that acquires, from the plurality of gaming machines, gaming machine information comprising paying-out information indicating a paying-out status of the game medium in each gaming machine, customer identification information identifying a plurality of customers who play the games with the gaming machines, and preference information indicating a preference of each customer for the game of the gaming machine;
a storage device in which each piece of information acquired by the second information acquisition unit is stored;
an information management unit that classifies the plurality of customers into a plurality of customer types based on the preference information while classifying the plurality of gaming machines into a plurality of gaming machine types based on the gaming machine information; and
a provided information producing unit that produces recommended gaming machine information indicating a recommended gaming machine for each customer from the gaming machine type and the customer type and to provide the recommended gaming machine information to the gaming machine,
wherein the display information producing unit of the gaming machine produces display recommended gaming machine information in a language corresponding to a customer's nationality indicated by the nationality information from the recommended gaming machine information provided from the gaming information providing device,
wherein the display information producing unit provides the display recommended gaming machine information to the display controller, and
wherein the display controller of the gaming machine causes the display device to display the recommended gaming machine information based on the display recommended gaming machine information.

7. The gaming system according to claim 6, wherein the preference information is paying-in information indicating a paying-in status of the game medium for the gaming machine in each customer.

8. A gaming machine information display method comprising:
a display control step of causing a display device to display a game content based on game content display information;
an information acquisition step of acquiring nationality information on a customer who plays a game; and
a display information producing step of producing the game content display information in a language corresponding to a customer's nationality indicated by the nationality information.

9. A program stored on a non-transitory computer-readable medium that causes a computer to perform a gaming machine information display method comprising:
a display control step of causing a display device to display a game content based on game content display information;
an information acquisition step of acquiring nationality information on a customer who plays a game; and
a display information producing step of producing the game content display information in a language corresponding to a customer's nationality indicated by the nationality information.

10. (canceled)

11. The gaming machine according to claim 2,
wherein the display information producing unit produces display information for a language selection screen in which one of a plurality of languages can be selected based on an input issuing an instruction to change a display language of the game content,
wherein the display information producing unit provides the display information for the language selection screen to the display controller,
wherein the display information producing unit produces the game content display information in the language selected in the language selection screen,
wherein the display information producing unit provides the game content display information to the display controller,
wherein the display controller causes the display device to display the language selection screen based on the display information for the language selection screen, and
wherein, when the display information producing unit provides second game content display information to the display controller after providing first game content display information to the display controller, the display controller causes the display device to display the game content based on the second game content display information instead of the first game content display information.
